(19) United States
(12) Patent Application Publication
(10) Pub. No.: US 2025/0283989 A1
(43) Pub. Date: Sep. 11, 2025

(54) METHODS FOR CARRIER OFFSET ESTIMATION AND PHASE-BASED TOF CALCULATION IN DOUBLE-SIDED TWO-WAY RANGING

(71) Applicant: Qorvo US, Inc., Greensboro, NC (US)

(72) Inventors: Igor Dotlic, Dublin (IE); Michael McLaughlin, Dublin (IE)

(21) Appl. No.: 19/033,678

(22) Filed: Jan. 22, 2025

Related U.S. Application Data
(60) Provisional application No. 63/562,745, filed on Mar. 8, 2024.

(51) Int. Cl. G01S 11/02; H04L 27/26

(52) U.S. Cl. CPC G01S 11/02; H04L 27/2657

(57) ABSTRACT

Disclosed is a method and wireless communication device for determining time-of-flight (TOF) in a two-way ranging system. The method involves performing a double-sided two-way ranging (DS-TWR) exchange between two devices, determining by way of processing circuitry of at least one of the devices a carrier frequency offset (CFO) of an initiator of one of the devices and a CFO of a responder of one of the devices, and response delay of the responder and a response delay of the initiator, thereby collecting exchange information. Other steps are filtering a CFO estimation by way of the processing circuitry; calculating by way of the processor a precise CFO estimation from the filtered CFO estimation and the exchange information; and calculating by way of the processor a TOF using the precise CFO estimation and the exchange information.

### RELATED APPLICATIONS

This application claims the benefit of provisional patent application Ser. No. 63/562,745, filed Mar. 8, 2024, the disclosure of which is hereby incorporated herein by reference in its entirety.

This application is related to U.S. patent application Ser. No. 18/583,966, filed Feb. 22, 2024, and titled METHOD OF TIME-OF-FLIGHT RANGING BETWEEN WIRELESS DEVICES, which claims the benefit of U.S. Provisional Application Ser. No. 63/489,863, filed Mar. 13, 2023, the disclosures of which are hereby incorporated herein by reference in their entireties.

### FIELD OF THE DISCLOSURE

The present disclosure relates to robust and efficient carrier frequency offset estimation methods for ultra-wideband two-way ranging systems, improving distance measurement precision in wireless applications.

### BACKGROUND

Two-way ranging (TWR) is a common technique used to determine the round-trip time of flight (TOF) between devices, from which distances can be calculated using the speed of light. There are two primary TWR methods: single-sided TWR (SS-TWR) and double-sided TWR (DS-TWR). SS-TWR involves a master device transmitting a packet to a slave device, followed by the slave replying with its own packet after a predetermined response delay. DS-TWR, on the other hand, involves both devices sending three or four packets between devices.

Both phase-based SS-TWR and DS-TWR suffer from potential errors due to carrier frequency offset (CFO) between devices, which can result in significant distance measurement errors if left unaddressed. While CFO estimation methods have been developed for various wireless technologies, these techniques often require high computational complexity or do not provide sufficient accuracy for precise distance measurements.

Furthermore, phase-based SS-TWR suffers from limitations related to response delays, which can introduce significant errors in TOF estimation if not properly accounted for. Although phase-based DS-TWR offers better precision than phase-based SS-TWR due to its higher number of packets exchanged, it still requires accurate CFO estimation to minimize distance measurement errors.

Therefore, there is a need for more robust and efficient methods for estimating CFOs in phase-based TWR systems using ultra-wideband technology. Accurate CFO estimation can significantly improve distance measurements in both phase-based SS-TWR and DS-TWR, ensuring reliable performance in various applications. Embodiments of the present disclosure aim to address this need by providing techniques for CFO estimation in wireless TWR systems, thus improving overall distance measurement accuracy and reliability.

Related-art methods for phase-based DS-TWR TOF calculation in the best-case scenario can resolve only a quarter of the wavelength in range, or equivalently, a quarter of the carrier period in TOF, whereas in other related-art the methodology for phase-based SS-TWF TOF calculation can resolve a half of the carrier period in TOF. On the other hand, the latter methodology is considerably less precise in comparison with the former methodology due to its usage of CFO estimation from the device that is typically rather noisy even after the filtering is applied. Therefore, there is a need to have the best from both worlds—a phase-based DS-TWR resolvable in TOF to a half of the carrier period without any loss in its precision.

### SUMMARY

Disclosed is a method and wireless communication device for determining time-of-flight (TOF) in a two-way ranging system. The method involves performing a double-sided two-way ranging (DS-TWR) exchange between two devices, determining by way of processing circuitry of at least one of the devices a carrier frequency offset (CFO) of an initiator of one of the devices and a CFO of a responder of one of the devices, and response delay of the responder and a response delay of the initiator, thereby collecting exchange information. Other steps are filtering a CFO estimation by way of the processing circuitry; calculating by way of the processing circuitry a precise CFO estimation from the filtered CFO estimation and the exchange information; and calculating by way of the processing circuitry a TOF using the precise CFO estimation and the exchange information.

The environment is the standard DS-TWR radio ranging protocol, common in ultra-wideband (UWB) ranging with additional received signal parameters, first path phases, being measured.

A benefit of the disclosed embodiment is the ability to resolve a half of the carrier period in TOF with high precision. Additional benefits may include, but are not limited to, the following:
phase-based (PB) DS-TWR protocol.
Raw CFO filtering.
Precise CFO estimation
Unity-interval PB-DS-TWR normalized TOF estimation
k_{M}-interval PB-DS-TWR normalized TOF estimation
½-interval PB-DS-TWR normalized TOF estimation.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a diagram of two wireless communication devices performing a phase-based double-sided two-way ranging (PB-DS-TWR) exchange.

FIG. 2 is a flow diagram of an exemplary PB-DS-TWR exchange like the one being executed as shown in FIG. 1.

FIG. 3 is a graph showing a phase-based single-sided two-way ranging (PB-SS-TWR) CFO estimation method with the wrapping problem.

FIG. 4 is a diagram showing a phase-based double-sided two-way ranging time of flight (PB-DS-TWR TOF) estimation using a refined carrier frequency offset (CFO) flowchart.

FIG. 5 is a graph showing the PB-DS-TWR CFO estimation method without the wrapping problem.

FIG. 6 is a diagram showing the refining PB-SS-TWR TOF measurement using a k_{M}-interval PB-DS-TWR TOF estimation flowchart.

FIG. 7 is a diagram showing the refining PB-SS-TWR TOF measurement using a ½-interval PB-DS-TWR TOF estimation flowchart.

FIG. 8 is a graph showing measured response delays per a measurement index.

FIG. 9 is a diagram showing CFO estimations: from the chip, exponential moving average filtered (\hat{ϵ}_{RI}⁰), and phase-based measurement (\hat{ϵ}_{RI}).

FIG. 10 is a graph showing standard deviation of different carrier period (T_{F}) estimation methods in meters.

FIG. 11 is a graph showing TOF estimations obtained by different formulas.

FIG. 12 is a diagram showing how the disclosed ranging methods may interact with communication devices such as wireless communication devices.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

The following terms are used in the present disclosure:
f_{c}—Carrier frequency of Initiator (hertz).
ω_{c}=2πf_{c}—Circular carrier frequency of Initiator (radians/second).
Δω_{R}—circular carrier frequency offset (CFO; radians/second) of Responder relative to Initiator.
Δω_{T}—circular CFO (radians/second) of Tag relative to Initiator.

$${ϵ}_{RI} = \frac{Δ {ω}_{R}}{{ω}_{c}}$$

relative CFO (skew) of Responder to Initiator (no unit).

$${ϵ}_{IR} = - \frac{Δ {ω}_{R}}{{ω}_{c} + Δ {ω}_{R}} \approx - {ϵ}_{RI}$$

relative CFO (skew) of Initiator to Responder (no unit).

$${ϵ}_{TI} = \frac{Δ {ω}_{T}}{{ω}_{c}}$$

relative CFO (skew) of Tag to Initiator (no unit).

$${ϵ}_{T R} = \frac{Δ {ω}_{T} - Δ {ω}_{R}}{{ω}_{c} + Δ {ω}_{R}}$$

relative CFO (skew) of Tag to Responder (no unit).
t_{F}—Time of flight (TOF) between Initiator and Responder (seconds).
t_{IT}—TOF between Initiator and Tag (seconds).
t_{RT}—TOF between Responder and Tag (seconds).
t_{D}=t_{IT}−t_{RT}—Time difference of arrival (TDOA) between Initiator and Responder measured by Tag (seconds).
φ_{P}^{R}—First path angle (FPA) of Poll packet measured by Responder (radians).
φ_{R}^{I}—FPA of Response packet measured by Initiator (radians).
φ_{F}^{R}—FPA of Final packet measured by Responder (radians).
φ_{P}^{T}—FPA of Poll packet measured by Tag (radians).
φ_{R}^{T}—FPA of Response packet measured by Tag (radians).
φ_{F}^{T}—FPA of Final packet measured by Tag (radians).
d_{I}—Response delay of Initiator (seconds).
d_{R}—Response delay of Responder (seconds).
r_{I}=2t_{F}+d_{R}—Round-trip time of Initiator (seconds).
r_{R}=2t_{F}+d_{I}—Round-trip time of Responder (seconds).
Δ(⋅)—Change of a given variable between consecutive two-way ranging exchanges (TWRs).
(̅⋅̅)̅—Mean value of a variable across TWRs.
[symbol] —Estimate of a given variable.
λ—Wavelength (meters).
θ_{R}—Initial oscillator phase offset of Responder to Initiator (radians).
θ_{T}—Initial oscillator phase offset of Tag to Initiator (radians).
x(mod v)—Unbiased modulus of x with respect to v; the result is always in

$$[ - \frac{v}{2} , + \frac{v}{2} )$$

interval; calculated as

$$( x + \frac{v}{2} ) \% v - \frac{v}{2} .$$

Here, “%” represents the standard modulus operation that produces results in [0, v) interval.

Assumptions are made as follows:
Transmitter oscillator phase is given to a pulse at the time of transmission.
Receiver oscillator phase is removed from a pulse at the time of reception.
Receiver conjugates resulting phasors. Therefore, reported first phase in the accumulator is the transmitter oscillator phase at the time of transmission subtracted from the receiver oscillator phase in the time of reception.
The whole preamble is observed as a single pulse.
The effect or correlation before CFO removal is observed via the main lobe phase of the ambiguity function of the code used.
Phase transitions between preambles should cancel out on two sides, as relative CFOs are approximately the same with opposite signs, so they are not included in the analysis.
CFO is constant during a phase-based double-sided two-way ranging (PB-DS-TWR); however, CFO can change between consecutive PB-DS-TWRs.

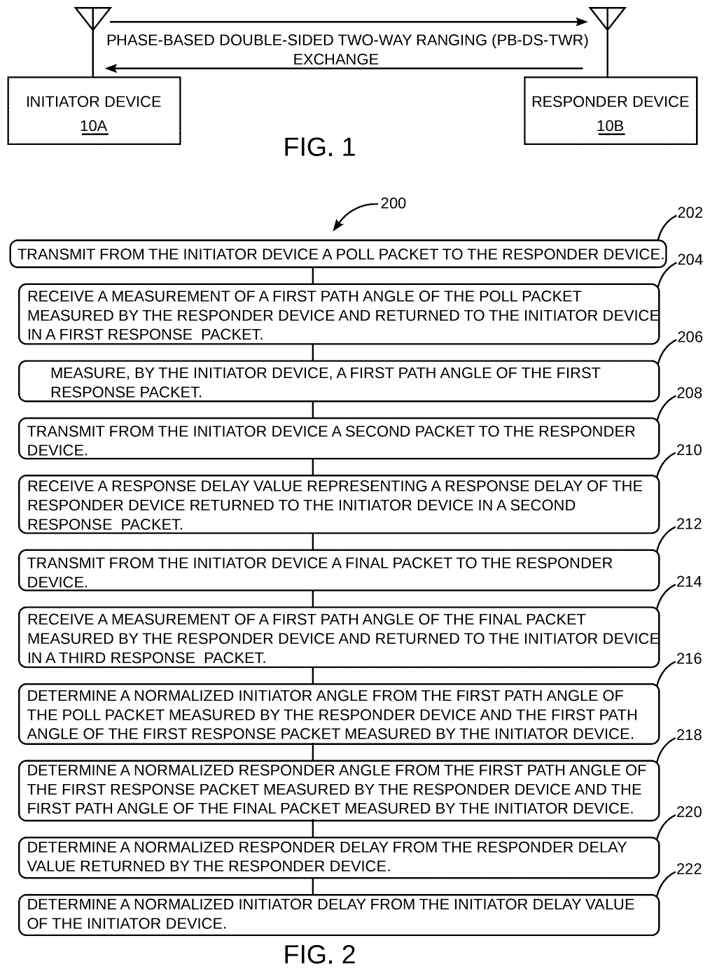

FIG. 1 is a diagram of two wireless communication devices performing a PB-DS-TWR exchange. A first one of the wireless communication devices is selectively configured as an initiator device 10A, while a second one of the wireless communication devices is selectively configured as a responder device 10B.

FIG. 2 is a flow diagram of an exemplary PB-DS-TWR exchange 200 like the one being executed as shown in FIG. 1 and depicted by arrows between the initiator device 10A and the responder device 10B. The process begins by transmitting from the initiator device 10A a poll packet to the responder device 10B (step 202). The initiator 10A then receives a first response packet containing a measurement of a first path angle of the poll packet (φ_{P}^{R}) measured by the responder device (step 204). A first path angle of the first response packet (φ_{R}^{I}) is measured as the response packet is received by the initiator device 10A (step 206). The exchange continues by transmitting from the initiator device 10A a second packet to the responder device 10B (step 208). The initiator device 10A then receives from the responder device 10B a second response packet containing a response delay value (d_{R}) representing a response delay of the responder device 10B (step 210). The initiator device 10A then transmits a final packet to the responder device 10B (step 212). The initiator 10A then receives a third response packet from the responder device 10B containing a measurement of a first path angle of the final packet (φ_{F}^{R}) measured by the responder device 10B (step 214). The process continues with determining the normalized initiator angle (\hat{Φ}_{I}) from the first path angle of the poll packet (φ_{P}^{R}) measured by the responder device 10 B and the first path angle of the first response packet (φ_{R}^{I}) measured by the initiator device 10A (step 216). A next step involves determining the normalized responder angle (\hat{Φ}_{R}) from the first path angle of the first response packet (φ_{R}^{I}) from the responder device 10B and measured by the initiator device 10A and the first path angle of the final packet (φ_{F}^{R}) measured by the responder device 10B (step 218). Another step proceeds with determining the normalized responder delay (D_{R}) from the response delay value (d_{R}) returned by the responder device 10B and received by the initiator device 10A (step 220). Yet another step proceeds with determining the normalized initiator delay (D_{I}) from an initiator delay value (d_{I}) of the initiator device 10A (step 222). These collected quantities are then used in phase-based time-of-flight formulas to determine a relatively highly accurate time-of-flight.

### Phase-Based Time-of-Flight Formulas

To recapitulate, the phase-based single-sided two-way ranging (PB-SS-TWR) formulas used to derive phase-based double-sided two-way ranging (PB-DS-TWR) formulas are the following:

$${T}_{F}^{I} = {Φ}_{I} + {ϵ}_{R I} {D}_{R} + {n}_{I} \qquad ( 1 )$$

$${T}_{F}^{R} = {Φ}_{R} + {ϵ}_{I R} {D}_{I} + {n}_{R} \qquad ( 2 )$$

In equation (1),

$${Φ}_{I} = \frac{{φ}_{P}^{R} + {φ}_{R}^{I}}{2 π}$$

is a normalized initiator angle calculated from a first path angle of a poll packet transmitted by an initiator device and measured by a responder device added to a first path angle of a response packet from the responder device and measured by the initiator device with the total divided by 2π, and D_{R}=f_{c}d_{R} and T_{F}=2f_{c}t_{F} are respective times normalized to carrier cycle, or, equivalently, distances normalized to λ.

Similarly, in equation (2),

$${Φ}_{R} = \frac{{φ}_{R}^{I} + {φ}_{F}^{R}}{2 π}$$

is a normalized responder angle calculated from the first path angle of a response packet from the responder device and measured by the initiator device added to a first path angle of a final packet from the initiator device and measured by the responder device with the total divided by 2π, and D_{I}=f_{c}d_{I} is normalized initiator delay.

Here, n_{I} and n_{R} are unknown integer numbers, representing the ambiguity of the TOF normalized to the carrier period (T_{F}). Hence, the estimation of the normalized TOF for the initiator SS-TWR will be:

$${\hat{T}}_{F}^{S S} = ( {\hat{Φ}}_{I} + {\hat{ϵ}}_{R I}^{0} {\hat{D}}_{R} ) ( mod 1 ) \qquad ( 3 A )$$

$${\hat{T}}_{F}^{S S} = ( {\hat{Φ}}_{R} - {\hat{ϵ}}_{R I}^{0} {\hat{D}}_{I} ) ( mod 1 ) \qquad ( 3 B )$$

Here, \hat{ϵ}_{RI}⁰ is a low-pass filtered CFO estimate from the chip, e.g., exponential moving average (EMA) or Kalman filter. This is done since the raw CFO from the device is typically too noisy to be directly used in phase-based ranging (PBR) TOF calculation.

### PBR DS-TWR Expressions Without Usage of CFO

Using ϵ_{IR}≈−ϵ_{RI} to eliminate CFO yields:

$${T}_{F}^{D S} = {k}_{I} {Φ}_{I} + {k}_{R} {Φ}_{R} + {k}_{I} {n}_{I} + {k}_{R} {n}_{R} \qquad ( 4 )$$

Here,

$${k}_{I} = \frac{{D}_{I}}{{D}_{I} + {D}_{R}} = \frac{{d}_{I}}{{d}_{I} + {d}_{R}} and {k}_{R} = \frac{{D}_{R}}{{D}_{I} + {D}_{R}} = \frac{{d}_{R}}{{d}_{I} + {d}_{R}} = 1 - {k}_{I} .$$

The caveat here is that T_{F} is resolvable with the accuracy of n_{I}k_{I}+n_{R}k_{R}, i.e., the resolvable interval is min (k_{I}, k_{R})=k_{M}. Hence, the estimation formula is:

$${\hat{T}}_{F}^{D S 1} = {\hat{k}}_{I} {\hat{Φ}}_{I} ( mod {\hat{k}}_{M} ) + {\hat{k}}_{R} {\hat{Φ}}_{R} ( mod {\hat{k}}_{M} ) \qquad ( 5 )$$

Here,

$${\hat{k}}_{I} = \frac{{\hat{D}}_{I}}{{\hat{D}}_{I} + {\hat{D}}_{R}} , {\hat{k}}_{R} = 1 - {\hat{k}}_{I} ,$$

and, \hat{k}_{M}=min (\hat{k}_{I}, \hat{k}_{R}).

In the best-case scenario of the roughly symmetrical

$$DS - TWR - {k}_{I} \approx {k}_{R} \approx \frac{1}{2} - {T}_{F}$$

is resolvable within ½ long interval.

This is a step back from equation (3), where T_{F} is resolvable within a unity-long interval. On the other hand, equation (3) is relatively less precise for calculating T_{F} estimation compared with equation (4), since it needs CFO estimation, which is relatively noisy even after filtering.

PB-DS-TWR Estimation with Usage of CFO

If equations (1) and (2) are averaged, one gets:

$${T}_{F}^{D S 2} = \frac{1}{2} ( {Φ}_{I} + {Φ}_{R} ) + \frac{{ϵ}_{RI}}{2} ( {D}_{R} - {D}_{I} ) + \frac{{n}_{I} + {n}_{R}}{2} \qquad ( 6 )$$

That is, its estimate can be calculated as:

$${\hat{T}}_{F}^{D S 2} = \frac{1}{2} ( ( {\hat{Φ}}_{I} + {\hat{Φ}}_{R} ) + {\hat{ϵ}}_{R I}^{0} ( {\hat{D}}_{R} - {\hat{D}}_{I} ) ) ( mod 1 ) \qquad ( 7 )$$

This approach requires CFO reading and filtering as PB-SS-TWR. Again, it gives resolvability of Δ\hat{T}_{F} within a ½ long interval as the best case above. The influence of the CFO estimation ER, on the precision of the resulting normalized TOF estimate depends on the asymmetry of the two ranging intervals.

### Methods of PB-DS-TWR TOF Estimation of the Present Disclosure

### Methods for CFO Refining in PB-DS-TWR

### 1. Resolving Integer and Fractional Parts of CFO

The largest source of error in PB-SS-TWR TOF estimation is CFO estimation from the chip; even with filtering the method still is not good enough to match the precision of PB-DS-TWR.

However, in DS-TWR, CFO can be estimated from the expression obtained by subtracting equation (1) from equation (2), considering that T_{F}^{I}=T_{F}^{R} and ϵ_{IR}≈−ϵ_{RI}:

$${ϵ}_{RI} = \frac{{Φ}_{R} - {Φ}_{I} + {n}_{R} - {n}_{I}}{{D}_{R} + {D}_{I}} = \frac{( {Φ}_{R} - {Φ}_{I} ) ( mod 1 )}{{D}_{R} + {D}_{I}} + \frac{n}{{D}_{R} + {D}_{I}} \qquad ( 8 )$$

As it can be seen, CFO, in

$$\frac{1}{{D}_{I} + {D}_{R}}$$

units, can be divided into an integer part and a fractional part, one that can be measured from the TWR phases. Then, the overall CFO can be estimated as:

$${\hat{ϵ}}_{RI} = \frac{( {\hat{Φ}}_{R} - {\hat{Φ}}_{I} ) ( mod 1 ) + \hat{n}}{{\hat{D}}_{R} + {\hat{D}}_{I}} \qquad ( 9 )$$

Here,

$$\hat{n} = ⌈ {\hat{ϵ}}_{R I}^{0} ( {\hat{D}}_{R} + {\hat{D}}_{I} ) ⌋ \qquad ( 10 )$$

represents an estimate of the integer part with “┌⋅┘” denoting rounding to the nearest integer.

The problem with the foregoing method is wrapping around of the phase part of the estimation due to the measurement noise when it is close to

$$\pm \frac{1}{2}$$

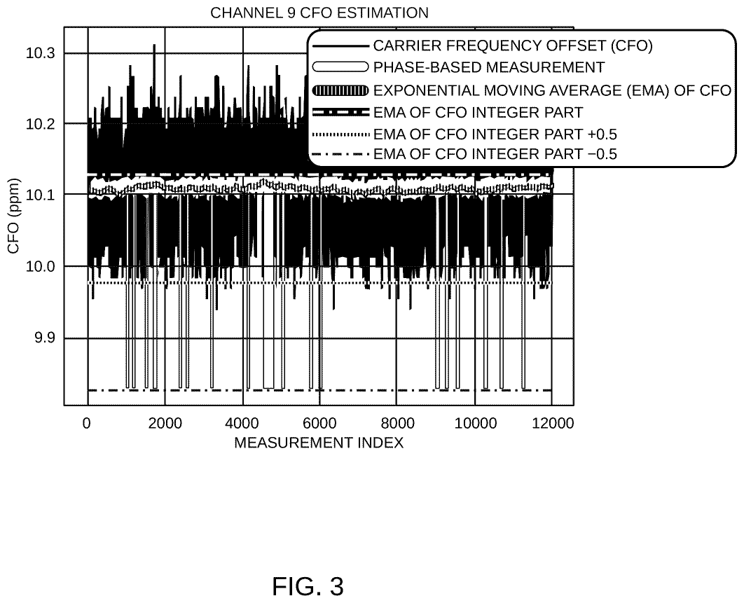

discontinuity, which is illustrated in FIG. 3.
II. Resolving the Difference from the Filtered CFO

To avoid the above problem, it is better to estimate the difference \hat{ϵ}_{RI}⁰−ϵ_{RI} in phase:

$${\hat{ϵ}}_{RI} = \frac{( {\hat{Φ}}_{R} - {\hat{Φ}}_{I} - {\hat{ϵ}}_{R I}^{0} ( {\hat{D}}_{R} + {\hat{D}}_{I} ) ) ( mod 1 )}{{\hat{D}}_{R} + {\hat{D}}_{I}} + {\hat{ϵ}}_{R I}^{0} \qquad ( 11 )$$

In other words, center the \hat{ϵ}_{RI} wrapping interval at \hat{ϵ}_{RI}⁰ and thus maximize the amount of measurement noise needed to wrap \hat{ϵ}_{RI}. Therefore, if the filtered CFO gives precision better than

$$\vert {\hat{ϵ}}_{R I}^{0} - {ϵ}_{RI} \vert < \frac{1}{2 ( {D}_{I} + {D}_{R} )} , \qquad ( 12 )$$

CFO can be successfully resolved.

### Pb-DS-TWR TOF Estimation Using Refined CFO

\hat{ϵ}_{RI} derived above can be used in equations (1) or (2) to get the PB-DS-TWR TOF estimate resolvable within a unity-long interval:

$${\hat{T}}_{F}^{D S 3} = ( {\hat{Φ}}_{I} + {\hat{ϵ}}_{R I} {\hat{D}}_{R} ) ( mod 1 ) \qquad ( 13 A )$$

$${\hat{T}}_{F}^{D S 3} = ( {\hat{Φ}}_{R} - {\hat{ϵ}}_{R I} {\hat{D}}_{I} ) ( mod 1 ) \qquad ( 13 B )$$

Note that the foregoing \hat{T}_{F}^{DS3} expression and the analogous PB-SS-TWR equation (3) differ only in the CFO estimate used.

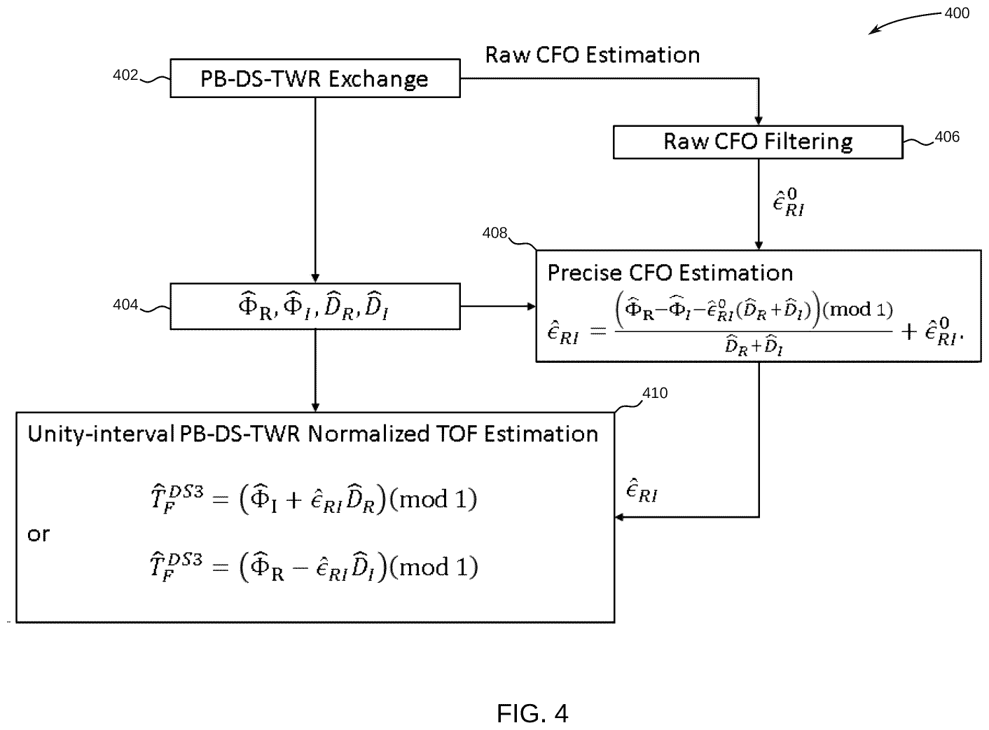

A flowchart of a first method 400 based upon the above equations is depicted in FIG. 4. The first method 400 begins with a PB-DS-TWR exchange between an initiator device and a responder device (step 402). In response, processing circuitry of the initiator device and/or the responder device generates the normalized initiator angle (\hat{Φ}_{I}), normalized responder angle (\hat{Φ}_{R}), the responder delay (\hat{D}_{R}), and the initiator delay (\hat{D}_{I}), (step 404). Relatively simultaneously, a raw (i.e., unfiltered) CFO estimation generated by the processing circuitry of the initiator device and/or responder device is filtered by a raw CFO filtering step (406). In at least one embodiment, the processing circuitry executes instructions that perform an exponential moving average that yields the filtering of the raw CFO estimation. Next, a precise CFO estimation is calculated by the processing circuitry when the values of step 404 are processed through equation (11) by way of the processing circuitry (step 408). A unity-interval PB-DS-TWR normalized TOF estimation is then calculated by the processing circuitry of the initiator device and/or the responder device using equation (13A) or (13B) (step 410).

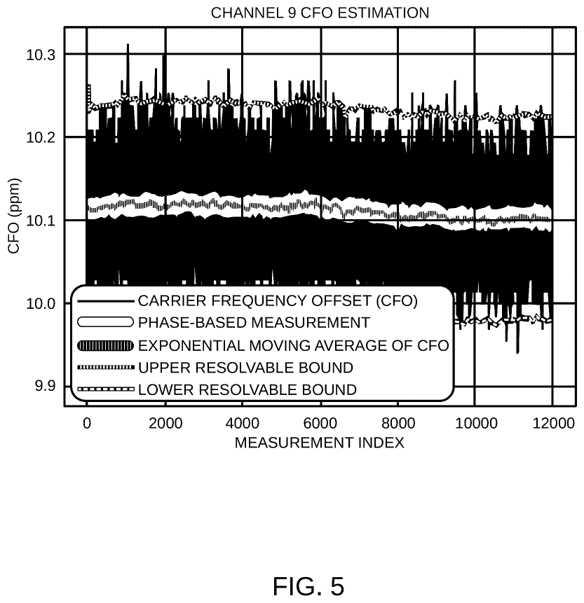

To illustrate how precise the filtered CFO estimation needs to be, look at f₀˜8 GHz (CH9) and two typical response delay values of d_{I}=d_{R}=250 μs (Auto-Ack) and d_{I}=d_{R}=1 ms; these values give \hat{ϵ}_{RI}⁰ precision requirements of 0.125 ppm and 0.03 ppm, respectively. As the response delays grow, the precision requirements tighten. For example, FIG. 5 is a graph showing the PB-DS-TWR CFO estimation method without the wrapping problem.

### PB-SS-TWR TOF Refining Using PB-DS-TWR TOF Estimate

The second approach for getting PB-DS-TWR TOF resolvable to unity interval is using PB-SS-TWR equation (3) to get a relatively rougher TOF estimate, by itself resolvable on a unity interval. Then, refine this estimate with the delta between TOFs of PB-DS-TWR and PB-SS-TWR resolved to the maximal interval that this delta can be resolved, which is the one of PB-DS-TWR, i.e., k_{M} or ½, depending on methodology used, as shown in equation (5) or equation (7), respectively. Thus, for equation (5) calculate it as

$${\hat{T}}_{F}^{DS 4} = ( ( {\hat{T}}_{F}^{D S 1} - {\hat{T}}_{F}^{S S} ) ( mod {k}_{M} ) + {\hat{T}}_{F}^{S S} ) ( mod 1 ) \qquad ( 14 )$$

and for equation (7) as

$${\hat{T}}_{F}^{DS 5} = ( ( {\hat{T}}_{F}^{DS 2} - {\hat{T}}_{F}^{SS} ) ( mod \frac{1}{2} ) + {\hat{T}}_{F}^{SS} ) ( mod 1 ) \qquad ( 15 )$$

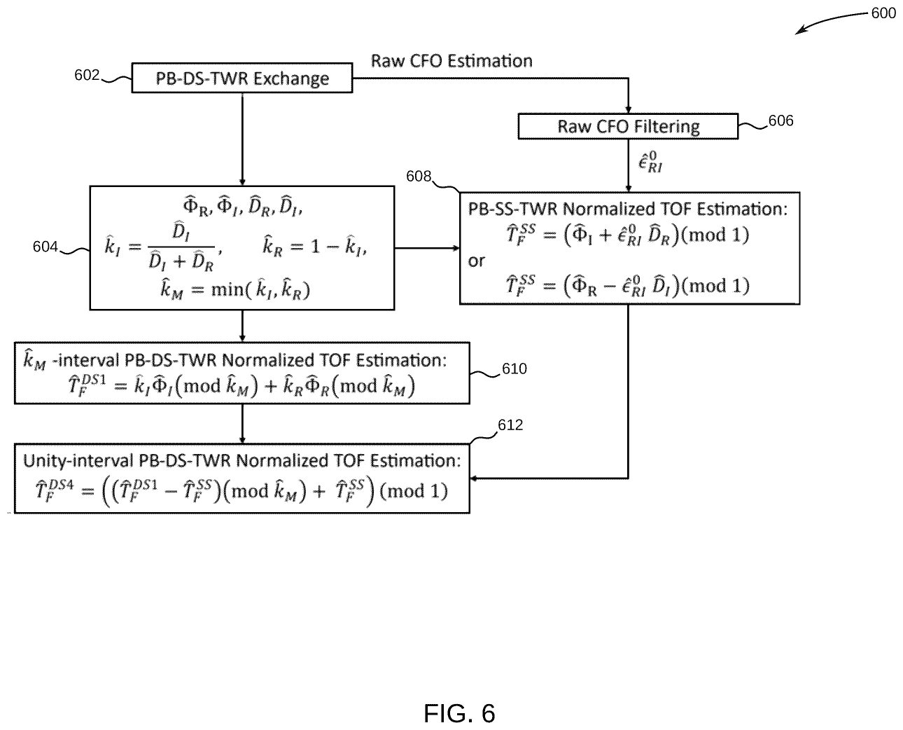

FIG. 6 is a diagram showing a second method 600 that refines PB-SS-TWR TOF measurement using a k_{M}-interval PB-DS-TWR TOF estimation flowchart. The second method 600 begins with a PB-DS-TWR exchange between an initiator device and a responder device (step 602). In response, a processing circuitry of the initiator device and/or the responder device generates the normalized initiator angle (\hat{Φ}_{I}), normalized responder angle (\hat{Φ}_{R}), the responder delay (\hat{D}_{R}), and the initiator delay (\hat{D}_{I}), and the resolvable interval that is min (\hat{k}_{I}, \hat{k}_{R})=\hat{k}_{M} (step 604). Relatively simultaneously, a raw (i.e., unfiltered) CFO estimation generated by the processing circuitry of the initiator device and/or the responder device is filtered by a raw CFO filtering step (606). In at least one embodiment, the processing circuitry executes instructions that perform an exponential moving average that yields the filtering of the raw CFO estimation. Next, the processing circuitry of the initiator device and/or the responder device calculates a PB-SS-TWR normalized TOF estimation using either equation (3A) or equation (3B) (step 608). Relatively simultaneously, a \hat{k}_{M}-interval PB-DS-TWR TOF estimation is calculated by the processing circuitry of the initiator device and/or the responder device using equation (5) (step 610). A unity-interval PB-DS-TWR normalized TOF estimation is then calculated by the processing circuitry of the initiator device and/or the responder device using equation (14) (step 612).

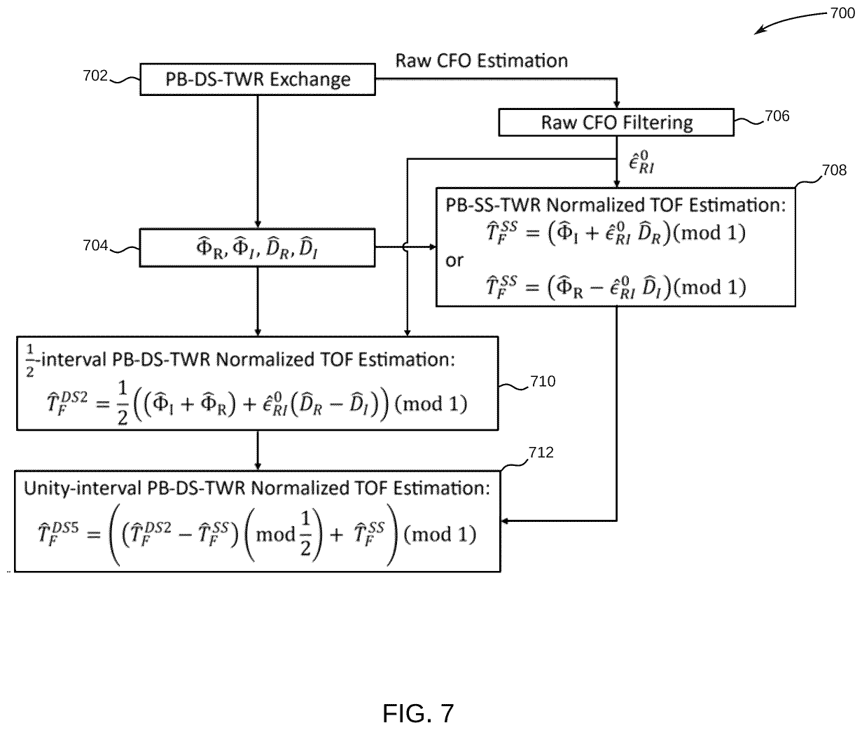

FIG. 7 is a diagram of a third method 700 that refines PB-SS-TWR TOF measurement by way of a processing circuitry of the initiator device and/or the responder device executing steps provided in a ½ interval PB-DS-TWR TOF estimation flowchart. The third method 700 begins with a PB-DS-TWR exchange between an initiator device and a responder device (step 702). In response, a processing circuitry of the initiator device and/or the responder device generates the normalized initiator angle (\hat{Φ}_{I}), normalized responder angle (\hat{Φ}_{R}), the responder delay (\hat{D}_{R}), and the initiator delay (\hat{D}_{I}), (step 704). Relatively simultaneously, a raw (i.e., unfiltered) CFO estimation generated by the processing circuitry of the initiator device and/or responder device is filtered by a raw CFO filtering step (706). In at least one embodiment, the processing circuitry executes instructions that perform an exponential moving average that yields the filtering of the raw CFO estimation. Next, a unity-interval PB-DS-TWR normalized TOF estimation is then calculated by the processing circuitry of the initiator device and/or the responder device using equation (3A) or equation (3B) (step 708). Relatively simultaneously, the ½-interval PB-DS-TWR TOF estimation is calculated by the processing circuitry of the initiator device and/or the responder device using equation (7) (step 710). A unity-interval PB-DS-TWR normalized TOF estimation is then calculated by the processing circuitry of the initiator device and/or the responder device using equation (15) (step 712).

### Experimental Results

For the testing of the new formula four-packet, PB-DS-TWR was used. The configuration was base pulse repetition frequency packet with a 64-symbol length synchronization header together with an 8-symbol length IEEE 802.15.4z synchronization frame delimiter and a 128-symbol length super deterministic codes scrambled timestamp sequence on IEEE 802.15.4 ultra-wideband Channel 9. To get different TOFs, along with different received signal levels (RSLs), the variable attenuator was used.

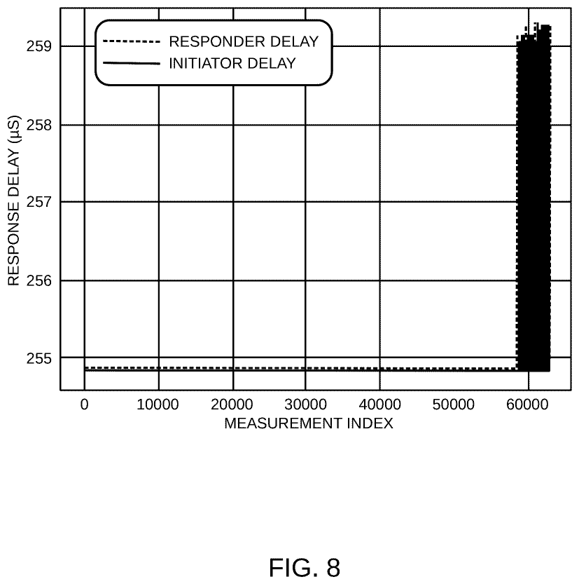

The measured response delays are plotted in FIG. 8. As FIG. 8 shows, response delays randomly increase for high measurement indices, i.e., low RSLs, due to the added IEEE 802.15.4 UWB PHY Reed-Solomon decoder error correction processing time at low RSLs, which are close to the receiver sensitivity.

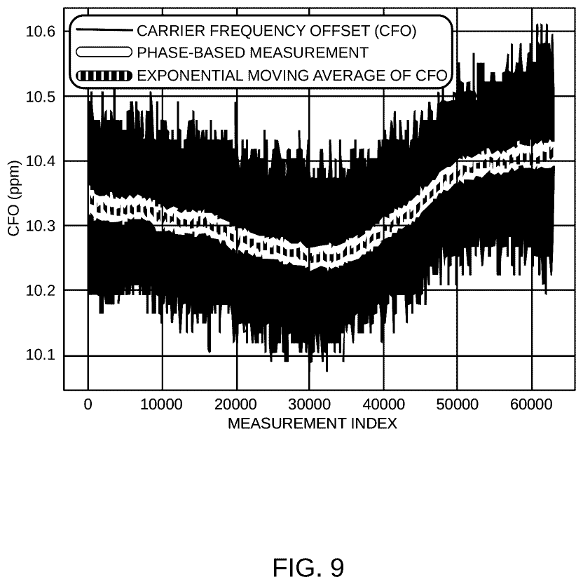

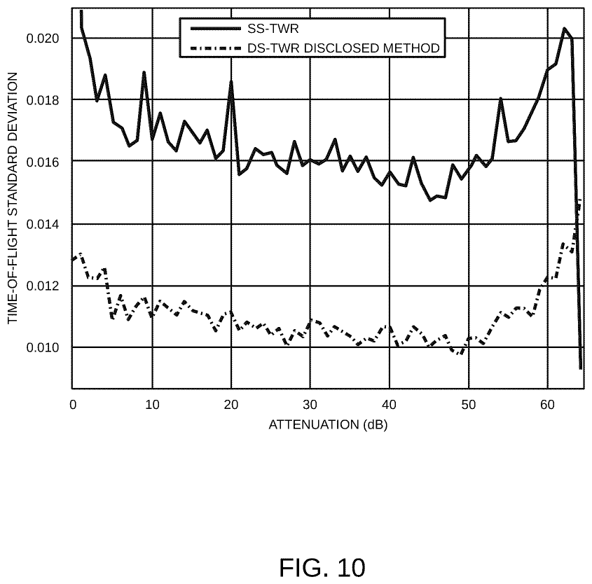

CFO estimates are plotted in FIG. 9; \hat{ϵ}_{RI}⁰, moves slower than \hat{ϵ}_{RI} due to the exponential moving average bandwidth, i.e., \hat{ϵ}_{RI} appears to be noisier. However, as it can be seen from FIG. 10 that \hat{ϵ}_{RI} is indeed a better estimate, since it produces a better T_{F} estimate compared with \hat{ϵ}_{RI}⁰. Therefore, equation (7) was used as the original DS-TWR measurement, i.e., “DS-TWR related-art method.” As equations (13A) and (15) produce the same results, only equation (13A) was plotted using “DS-TWR disclosed method.”

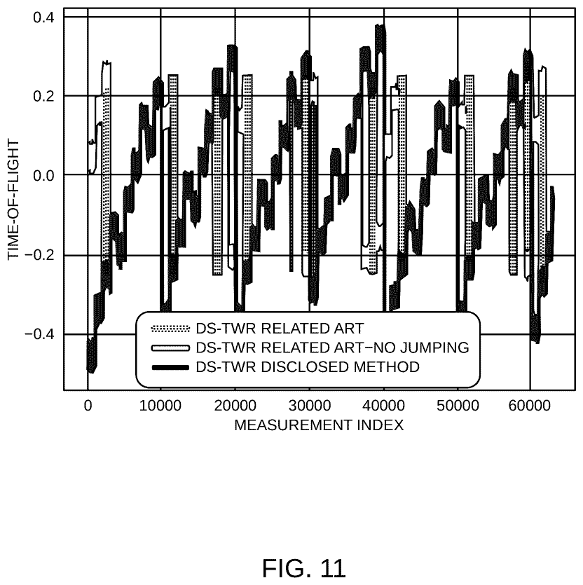

As FIG. 11 shows, the new formula indeed resolves to the full unity-length interval compared with the old formula, which resolves to a ½ long interval; when T_{F} value is close to

$$\pm \frac{1}{2}$$

discontinuity, it often jumps on the other side of the interval due to the measurement noise. This is not the case with the new formula.

When both equations resolve to the same ½ long interval, their results are indeed the same, as they both represent solutions of the same system of linear equations with integer ambiguities. This can also be seen in FIG. 10 where standard deviations of both methods, when jumping is removed, completely overlap.

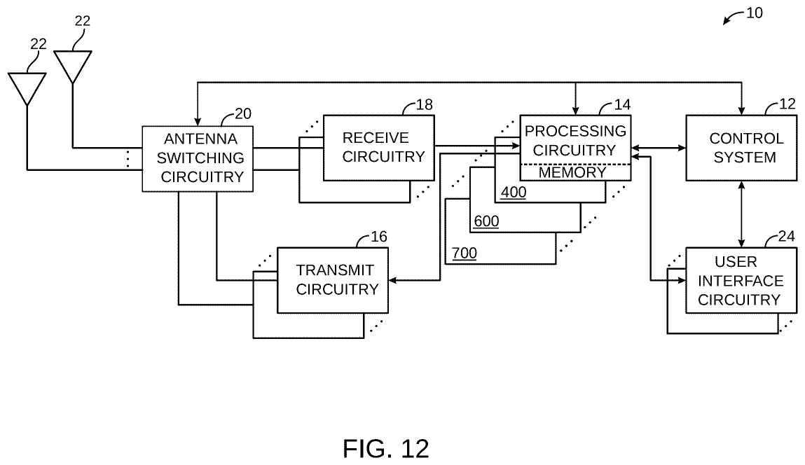

With reference to FIG. 12, the concepts described above may be implemented in various types of wireless communication device 10 that may selectively configured as either of the initiator device 10A or responder device 10B (FIG. 1), such as mobile terminals, smart watches, tablets, computers, navigation devices, access points, and the like that support wireless communications, such as cellular, wireless local area network (WLAN), Bluetooth, near-field communications, and ultra-wideband ranging. The communication device 10 will generally include a control system 12, processing circuitry 14 that has memory that is configured to store executable instructions for the SS-TWR method 400 (FIG. 4) and/or the DS-TWR method 600 (FIG. 6), transmit circuitry 16, receive circuitry 18, antenna switching circuitry 20, multiple antennas 22, and user interface circuitry 24. The receive circuitry 18 receives radio frequency signals including ultra-wide bandwidth signals via the antennas 22 and through the antenna switching circuitry 20 from one or more basestations and or other wireless communication devices configured like wireless communication device 10. A low-noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams.

The processing circuitry 14 processes the digitized received signal to extract the information or data bits conveyed in the received signal. This processing typically comprises demodulation, decoding, and error correction operations. In embodiments of the present disclosure, the processing circuitry is further configured to execute the executable instructions for the PB-DS-TWR method 400 and/or the PB-SS-TWR method 600, and/or the PB-DS-TWR method 700 to determine range by way of time-of-flight of radio signals transmitted and received between one or more wireless communication devices configured like wireless communication device 10. The processing circuitry 14 is generally implemented in one or more digital signal processors and application-specific integrated circuits.

For transmission, the processing circuitry 14 receives digitized data, which may represent voice, data, or control information, from the control system 12, which it encodes for transmission. The encoded data is output to the transmit circuitry 16, where it is used by a modulator to modulate a carrier signal that is at a desired transmit frequency or frequencies, such as ultra-wideband frequencies, which span 3.1 GHz to 10.5 GHZ. The bandwidth of ultra-wideband is greater than 500 MHz.

A power amplifier will amplify the modulated carrier signal to a level appropriate for transmission and deliver the modulated carrier signal through the antenna switching circuitry 20 to the antennas 22. The antennas 22 and the replicated transmit circuitry 16 and receive circuitry 18 may provide spatial diversity. Modulation and processing details will be understood by those skilled in the art.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A method performed in an initiator device for determining time-of-flight (TOF) between the initiator device and a responder device comprising:
obtaining a raw carrier frequency offset (CFO) estimation, a normalized initiator angle (\hat{Φ}_{I}), a normalized responder angle (\hat{Φ}_{R}), a normalized responder delay (D_{R}), and a normalized initiator delay (D_{I}) based on a phase-based double-sided two-way ranging (PB-DS-TWR) exchange with the responder device;
filtering the raw carrier frequency offset (CFO) estimation to provide a filtered CFO estimation (\hat{ϵ}_{RI}⁰);
calculating a precise CFO estimation (\hat{ϵ}_{RI}) based on the filtered CFO estimation (\hat{ϵ}_{RI}⁰), normalized initiator angle (\hat{Φ}_{I}), and the normalized responder angle (\hat{Φ}_{R}); and
calculating the TOF based on the precise CFO estimation (\hat{ϵ}_{RI}), the normalized responder delay (D_{R}), and the normalized initiator delay (D_{I}).

2. The method of claim 1 wherein filtering the raw CFO estimation is achieved through use of an exponential moving average filter.

3. The method of claim 1 wherein the PB-DS-TWR exchange comprises:
transmitting from the initiator device a poll packet to a responder device;
receiving a measurement of a first path angle of the poll packet (φ_{P}^{R}) measured by the responder device and returned to the initiator device in a first response packet;
measuring, by the initiator device, a first path angle of the first response packet (φ_{R}^{I});
transmitting from the initiator device a second packet to the responder device;
receiving from the responder device a response delay value (d_{R}) representing a response delay of the responder device in a second response packet;
transmitting from the initiator device a final packet to the responder device;
receiving a measurement of a first path angle of the final packet (φ_{F}^{R}) measured by the responder device and returned to the initiator device in a third response packet;
determining the normalized initiator angle (\hat{Φ}_{I}) from the first path angle of the poll packet (φ_{P}^{R}) measured by the responder device and the first path angle of the first response packet (φ_{R}^{I}) measured by the initiator device;
determining the normalized responder angle (\hat{Φ}_{R}) from the first path angle of the first response packet (φ_{R}^{I}) from the responder device and measured by the initiator device and the first path angle of the final packet (φ_{F}^{R}) measured by the responder device;
determining the normalized responder delay (D_{R}) from the response delay value (d_{R}) returned by the responder device; and
determining the normalized initiator delay (D_{I}) from an initiator delay value (d_{I}) of the initiator device.

4. The method of claim 3 wherein determining the normalized initiator angle (\hat{Φ}_{I}) is calculated using the equation
$${Φ}_{I} = \frac{{φ}_{P}^{R} + {φ}_{R}^{I}}{2 π} .$$

5. The method of claim 3 wherein determining the normalized responder angle (\hat{Φ}_{R}) is calculated using the equation
$${Φ}_{R} = \frac{{φ}_{R}^{I} + {φ}_{F}^{R}}{2 π} .$$

6. The method of claim 3 wherein determining the normalized initiator delay (D_{I}) is calculated using the equation D_{I}=f_{c}d_{I}, where f_{c} is a carrier frequency of the initiator device in Hertz.

7. The method of claim 3 wherein determining the normalized responder delay (D_{R}) is calculated using the equation D_{R}=f_{c}d_{R}, where f_{c} is a carrier frequency of the initiator device in Hertz.

8. The method of claim 3 wherein the precise CFO estimation is calculated using the equation
$${\hat{ϵ}}_{RI} = \frac{( {\hat{Φ}}_{R} - {\hat{Φ}}_{I} - {\hat{ϵ}}_{RI}^{0} ( {\hat{D}}_{R} + {\hat{D}}_{I} ) ) ( mod 1 )}{{\hat{D}}_{R} + {\hat{D}}_{I}} + {\hat{ϵ}}_{RI}^{0} .$$

9. The method of claim 3 wherein the TOF is calculated using the equation
$${\hat{T}}_{F}^{DS 3} = ( {\hat{Φ}}_{I} + {\hat{ϵ}}_{RI} {\hat{D}}_{R} ) ( mod 1 ) .$$

10. The method of claim 3 wherein the TOF is calculated using the equation
$${\hat{T}}_{F}^{DS 3} = ( {\hat{Φ}}_{R} - {\hat{ϵ}}_{RI} {\hat{D}}_{I} ) ( mod 1 ) .$$

11. A wireless communication device comprising:
receive circuitry configured to receive packets encoded on radio frequency (RF) signals;
transmit circuitry configured to modulate a carrier signal with the packets and transmit the packets; and
processing circuitry configured to:
obtain a raw carrier frequency offset (CFO) estimation, a normalized initiator angle (\hat{Φ}_{I}), a normalized responder angle (\hat{Φ}_{R}), a normalized responder delay (D_{R}), and a normalized initiator delay (D_{I}) based on a phase-based double-sided two-way ranging (PB-DS-TWR) exchange with a responder device;
filter the raw carrier frequency offset (CFO) estimation to provide a filtered CFO estimation (\hat{ϵ}_{RI}⁰);
calculate a precise CFO estimation (\hat{ϵ}_{RI}) based on the filtered CFO estimation (\hat{ϵ}_{RI}⁰), the normalized initiator angle (\hat{Φ}_{I}), and the normalized responder angle (\hat{Φ}_{R}); and
calculate the TOF based on the precise CFO estimation (\hat{ϵ}_{RI}), the normalized responder delay (D_{R}), and the normalized initiator delay (D_{I}).

12. A method performed in an initiator device for determining time-of-flight (TOF) between the initiator device and a responder device comprising:
obtaining a raw carrier frequency offset (CFO) estimation, a normalized initiator angle (\hat{Φ}_{I}), a normalized responder angle (\hat{Φ}_{R}), a normalized responder delay (D_{R}), and a normalized initiator delay (D_{I}) based on a phase-based double-sided two-way ranging (PB-DS-TWR) exchange with the responder device;
filtering a raw carrier frequency offset (CFO) estimation to provide a filtered CFO estimation (\hat{ϵ}_{RI}⁰);
calculating a phase-based single-sided two-way ranging (PB-SS-TWR) normalized TOF estimation based on the filtered CFO estimation (\hat{ϵ}_{RI}⁰), the normalized initiator angle (\hat{Φ}_{I}), the normalized responder angle (\hat{Φ}_{R}), the normalized responder delay (D_{R}), and the normalized initiator delay (D_{I});
calculating a resolvable interval (\hat{k}_{M}) phase-based double-sided two-way ranging (\hat{k}_{M}-interval PB-DS-TWR) normalized TOF estimation based on the normalized initiator angle (\hat{Φ}_{I}), the normalized responder angle (\hat{Φ}_{R}), the normalized responder delay (D_{R}), and the normalized initiator delay (D_{I}); and
refining the PB-SS-TWR normalized TOF estimation using the \hat{k}_{M}-interval PB-DS-TWR normalized TOF estimation to provide a unity-interval PB-DS-TWR normalized TOF estimation.

13. The method of claim 12 wherein the CFO estimation is filtered by processing circuitry using an exponential moving average filter.

14. The method of claim 12 wherein the PB-DS-TWR exchange comprises:
transmitting from the initiator device a poll packet to the responder device;
receiving a measurement of a first path angle of the poll packet (φ_{P}^{R}) measured by the responder device and returned to the initiator device in a first response packet;
measuring, by the initiator device, a first path angle of the first response packet (φ_{R}^{I});
transmitting from the initiator device a second packet to the responder device;
receiving from the responder device a response delay value (d_{R}) representing a response delay of the responder device in a second response packet;
transmitting from the initiator device a final packet to the responder device;
receiving a measurement of a first path angle of the final packet (φ_{F}^{R}) measured by the responder device and returned to the initiator device in a third response packet;
determining the normalized initiator angle (\hat{Φ}_{I}) from the first path angle of the poll packet (φ_{P}^{R}) measured by the responder device and the first path angle of the first response packet (φ_{R}^{I}) measured by the initiator device;
determining the normalized responder angle (\hat{Φ}_{R}) from the first path angle of the first response packet (φ_{R}^{I}) from the responder device and measured by the initiator device and the first path angle of the final packet (φ_{F}^{R}) measured by the responder device;
determining the normalized responder delay (D_{R}) from the response delay value (d_{R}) returned by the responder device; and
determining the normalized initiator delay (D_{I}) from an initiator delay value (d_{I}) of the initiator device.

15. The method of claim 14 wherein determining the normalized initiator angle (\hat{Φ}_{I}) is calculated using the equation
$${Φ}_{I} = \frac{{φ}_{P}^{R} + {φ}_{R}^{I}}{2 π} .$$

16. The method of claim 14 wherein determining the normalized responder angle (\hat{Φ}_{R}) is calculated using the equation
$${Φ}_{R} = \frac{{φ}_{R}^{I} + {φ}_{F}^{R}}{2 π} .$$

17. The method of claim 14 wherein determining the resolvable interval (\hat{k}_{M}) employs equations
$${\hat{k}}_{I} = \frac{{\hat{D}}_{I}}{{\hat{D}}_{I} + {\hat{D}}_{R}}$$
and \hat{k}_{R}=1−\hat{k}_{I} where \hat{k}_{M} is equal to a minimum value of \hat{k}_{I} and \hat{k}_{R}.

18. The method of claim 17 wherein a minimum interval PB-SS-TWR normalized TOF estimation is calculated using the equation \hat{T}_{F}^{DS1}=\hat{k}_{I}\hat{Φ}_{I}(mod \hat{k}_{M})+\hat{k}_{R}\hat{Φ}_{R}(mod \hat{k}_{M}).

19. The method of claim 18 wherein the PB-SS-TWR normalized TOF estimation is calculated using the equation \hat{T}_{F}^{SS}=(Φ_{I}+\hat{ϵ}_{RI}⁰ \hat{D}_{R})(mod 1).

20. The method of claim 19 wherein the unity-interval PB-SS-TWR normalized TOF estimation is calculated using the equation \hat{T}_{F}^{DS4}=((\hat{T}_{F}^{DS1}−\hat{T}_{F}^{SS})(mod k_{M})+\hat{T}_{F}^{SS})(mod 1).

21. The method of claim 18 wherein the PB-SS-TWR normalized TOF estimation is calculated using the equation \hat{T}_{F}^{SS}=(\hat{Φ}_{R}−\hat{ϵ}_{RI}⁰ \hat{D}_{I})(mod 1).

22. The method of claim 21 wherein the unity-interval PB-DS-TWR normalized TOF estimation is calculated using the equation \hat{T}_{F}^{DS4}=((\hat{T}_{F}^{DS1}−\hat{T}_{F}^{SS})(mod k_{M})+\hat{T}_{F}^{SS})(mod 1).

23. A wireless communication device comprising:
receive circuitry configured to receive packets encoded on radio frequency (RF) signals;
transmit circuitry configured to modulate a carrier signal with the packets and transmit the packets; and
processing circuitry configured to:
obtain a raw carrier frequency offset (CFO) estimation, a normalized initiator angle (\hat{Φ}_{I}), a normalized responder angle (\hat{Φ}_{R}), a normalized responder delay (D_{R}), and a normalized initiator delay (D_{I}) based on a phase-based double-sided two-way ranging (PB-DS-TWR) exchange with the responder device;
filter a raw carrier frequency offset (CFO) estimation to provide a filtered CFO estimation (\hat{ϵ}_{RI}⁰);
calculate a phase-based single-sided two-way ranging (PB-SS-TWR) normalized TOF estimation based on the filtered CFO estimation (\hat{ϵ}_{RI}⁰), the normalized initiator angle (\hat{Φ}_{I}), the normalized responder angle (\hat{Φ}_{R}), the normalized responder delay (D_{R}), and the normalized initiator delay (D_{I});
calculate a resolvable interval (\hat{k}_{M}) phase-based double-sided two-way ranging (\hat{k}_{M}-interval PB-DS-TWR) normalized TOF estimation based on the normalized initiator angle (\hat{Φ}_{I}), the normalized responder angle (\hat{Φ}_{R}), the normalized responder delay (D_{R}), and the normalized initiator delay (D_{I}); and
refine the PB-SS-TWR normalized TOF estimation using the \hat{k}_{M}-interval PB-DS-TWR normalized TOF estimation to provide a unity-interval PB-DS-TWR normalized TOF estimation.

24. A method performed in an initiator device for determining time-of-flight (TOF) between the initiator device and a responder device comprising:
obtaining a raw carrier frequency offset (CFO) estimation, a normalized initiator angle (\hat{Φ}_{I}), a normalized responder angle (\hat{Φ}_{R}), a normalized responder delay (D_{R}), and a normalized initiator delay (D_{I}) based on a phase-based double-sided two-way ranging (PB-DS-TWR) exchange with the responder device;
filtering a raw carrier frequency offset (CFO) estimation to provide a filtered CFO estimation (\hat{ϵ}_{RI}⁰);
calculating a phase-based single-sided two-way ranging (PB-SS-TWR) normalized TOF estimation based on the filtered CFO estimation (\hat{ϵ}_{RI}⁰), the normalized initiator angle (\hat{Φ}_{I}), the normalized responder angle (\hat{Φ}_{R}), the normalized responder delay (D_{R}), and the normalized initiator delay (D_{I});
calculating a resolvable ½-interval phase-based double-sided two-way ranging (½-interval PB-DS-TWR) normalized TOF estimation based on the normalized initiator angle (\hat{Φ}_{I}), the normalized responder angle (\hat{Φ}_{R}), the normalized responder delay (D_{R}), the normalized initiator delay (D_{I}), and the filtered CFO estimation (\hat{ϵ}_{RI}⁰); and
refining the PB-SS-TWR normalized TOF estimation using the ½-interval PB-DS-TWR normalized TOF estimation to provide a unity-interval PB-DS-TWR normalized TOF estimation.

25. The method of claim 24 wherein the CFO estimation is filtered by processing circuitry using an exponential moving average filter.

26. The method of claim 24 wherein the PB-DS-TWR exchange comprises:
transmitting from the initiator device a poll packet to a responder device;
receiving a measurement of a first path angle of the poll packet (φ_{P}^{R}) measured by the responder device and returned to the initiator device in a first response packet;
measuring, by the initiator device, a first path angle of the first response packet (φ_{R}^{I});
transmitting from the initiator device a second packet to the responder device;
receiving from the responder device a response delay value (d_{R}) representing a response delay of the responder device in a second response packet;
transmitting from the initiator device a final packet to the responder device;
receiving a measurement of a first path angle of the final packet (φ_{F}^{R}) measured by the responder device and returned to the initiator device in a third response packet;
determining the normalized initiator angle (\hat{Φ}_{I}) from the first path angle of the poll packet (φ_{P}^{R}) measured by the responder device and the first path angle of the first response packet (φ_{R}^{I}) measured by the initiator device;
determining the normalized responder angle (\hat{Φ}_{R}) from the first path angle of the first response packet (φ_{R}^{I}) from the responder device and measured by the initiator device and the first path angle of the final packet (φ_{F}^{R}) measured by the responder device;
determining the normalized responder delay (D_{R}) from the response delay value (d_{R}) returned by the responder device; and
determining the normalized initiator delay (D_{I}) from an initiator delay value (d_{I}) of the initiator device.

27. The method of claim 26 wherein determining the normalized initiator angle (\hat{Φ}_{I}) is calculated using the equation
$${Φ}_{I} = \frac{{φ}_{P}^{R} + {φ}_{R}^{I}}{2 π} .$$

28. The method of claim 26 wherein determining the normalized responder angle (\hat{Φ}_{I}) is calculated using the equation
$${Φ}_{R} = \frac{{φ}_{R}^{I} + {φ}_{F}^{R}}{2 π} .$$

29. The method of claim 26 wherein the ½-interval resolvable interval PB-DS-TWR normalized TOF estimation is calculated using the equation
$${\hat{T}}_{F}^{DS 2} = \frac{1}{2} ( ( {\hat{Φ}}_{I} + {\hat{Φ}}_{R} ) + {\hat{ϵ}}_{RI}^{0} ( {\hat{D}}_{R} - {\hat{D}}_{I} ) ) ( mod 1 ) .$$

30. The method of claim 29 wherein the PB-SS-TWR normalized TOF estimation is calculated using the equation \hat{T}_{F}^{SS}=(Φ_{I}+\hat{ϵ}_{RI}⁰ D_{R})(mod 1).

31. The method of claim 30 wherein the unity-interval PB-DS-TWR normalized TOF estimation is calculated using the equation
$${\hat{T}}_{F}^{DS 5} = ( ( {\hat{T}}_{F}^{DS 2} - {\hat{T}}_{F}^{SS} ) ( mod \frac{1}{2} ) + {\hat{T}}_{F}^{SS} ) ( mod 1 ) .$$

32. The method of claim 29 wherein the PB-SS-TWR normalized TOF estimation is calculated using the equation \hat{T}_{F}^{SS}=(Φ_{R}+\hat{ϵ}_{RI}⁰ D_{I})(mod 1).

33. The method of claim 32 wherein the unity-interval PB-DS-TWR normalized TOF estimation is calculated using the equation
$${\hat{T}}_{F}^{DS 5} = ( ( {\hat{T}}_{F}^{DS 2} - {\hat{T}}_{F}^{SS} ) ( mod \frac{1}{2} ) + {\hat{T}}_{F}^{SS} ) ( mod 1 ) .$$

34. A wireless communication device comprising:
obtain a raw carrier frequency offset (CFO) estimation, a normalized initiator angle (\hat{Φ}_{I}), a normalized responder angle (\hat{Φ}_{R}), a normalized responder delay (D_{R}), and a normalized initiator delay (D_{I}) based on a phase-based double-sided two-way ranging (PB-DS-TWR) exchange with the responder device;
filter a raw carrier frequency offset (CFO) estimation to provide a filtered CFO estimation (\hat{ϵ}_{RI}⁰);
calculate a resolvable ½-interval phase-based double-sided two-way ranging (½-interval PB-DS-TWR) normalized TOF estimation based on the normalized initiator angle (\hat{Φ}_{I}), the normalized responder angle (\hat{Φ}_{R}), the normalized responder delay (D_{R}), the normalized initiator delay (D_{I}), and the filtered CFO estimation (\hat{ϵ}_{RI}⁰); and
refine the PB-SS-TWR normalized TOF estimation using the ½-interval PB-DS-TWR normalized TOF estimation to provide a unity-interval PB-DS-TWR normalized TOF estimation.
